(19) United States
(12) Patent Application Publication
(10) Pub. No.: US 2022/0372302 A1
(43) Pub. Date: Nov. 24, 2022

(54) COATING OF TEXTILE MATERIALS

(71) Applicant: Friedrich-Schiller-Universitaet Jena, Jena (DE)

(72) Inventors: Thomas KUTSCHIN, Jena (DE); Patrick BRÄUTIGAM, Jena (DE); Maik WEISSE, Jena (DE); Marcus FRANKE, Jena (DE); Michael STELTER, Chemnitz (DE)

(21) Appl. No.: 17/596,446

(22) PCT Filed: Jun. 10, 2020
(86) PCT No.: PCT/DE2020/100484

§ 371 Date: Dec. 10, 2021

(30) Foreign Application Priority Data
Jun. 11, 2019 (DE) 10 2019 004 041.4

(51) Int. Cl. C09D 1/00; C09D 7/40; C08K 3/22; D06M 15/667; D06M 11/36; C09D 7/63

(52) U.S. Cl. CPC C09D 1/00; C09D 7/68; C08K 3/22; D06M 15/667; D06M 11/36; C09D 7/63; D06M 2200/12; D06M 2200/01

(57) ABSTRACT

The present invention comprises the coating and modification of textile materials in order to provide them with water-repellent properties. The object of the invention was to hydrophobize textiles loaded with metal oxide, wherein the hydrophobing agent presented here is non-toxic and environmentally friendly, adhering to the metal oxide surface considerably more stably and without the use of additional dispersants and binders, which also takes environmental aspects into account. The object is achieved by the use according to the invention of metal oxide particles and/or metal hydroxide particles of group IVB, IIB or IIIA or mixtures thereof, wherein said particles are present in a size range of 110 nm-10 μm, for the coating of textile materials and their treatment after application to the textile with phosphoric or phosphonic acid ester derivatives of the general form OP(OH)₂OR or OP(OH)₂R, wherein R is a hydrophobic residue in the form of aliphatic, branched or unbranched, alicyclic or aromatic hydrocarbon groups having 5-40 carbon atoms.

The invention relates to coating of textile materials according to the generic type of the patent claims.

Methods and materials for generating water-repellent surfaces are of great interest for the production of many different products, such as paints and varnishes, glasses, and building materials, as well as textiles. The hydrophobic properties of objects treated in this way not only protect them from water, but also ensure self-cleaning effects by reducing the adhesion of dirt particles, for example, which benefits the appearance on the one hand and the service life of these products on the other.

To make the relevant surfaces hydrophobic, fluorine-containing polymers or silanes or siloxanes are typically used, which are useful for achieving the largest possible contact angle between water droplets and the treated surface, but are toxic and harmful to the environment and also problematic due to their longevity.

Silanes and siloxanes can be used in particular when the material to be treated has freely accessible hydroxyl groups to which the organosilicon compounds can dock, which is the case, for example, on metal oxide surfaces.

One strategy for making textiles hydrophobic in this way is to load them with metal oxide particles beforehand and then modify them with the silicon-containing organic molecules just mentioned. This approach is followed in patent U.S. Pat. No. 7,879,743B2, wherein mainly fluorine-free silanes or siloxanes are used, so that the mass fraction of fluorine in the treated textile can be brought to a range of 20-500 ppm. However, the use of halogenated compounds is not completely avoided here either, and the use of halogen-free organosilicon compounds also has some disadvantages, such as expensive production, complicated handling and moderate stability of connection to the surface to be treated.

Due to the disadvantages just mentioned that organosilicon compounds have, the use of alternative, non-toxic and environmentally friendly hydrophobing reagents is desirable. In patent EP2102406B1, surface-modified metal oxide particles are used to make textiles hydrophobic and are applied to the textile fibers via a (fluorine-containing) dispersant and binder. In addition to silanes, carboxylic acids and carboxylic acid derivatives such as acid anhydrides or acid halides with hydrophobic residues are also described for the surface treatment of the metal oxides.

Although the use of halogen-free carboxylic acid derivatives, in particular, as hydrophobic modifiers for metal oxide particles represents an environmentally friendly alternative to (fluorinated) organosilicon compounds, the stability of these modifiers is limited by the carboxylic acid anchor group on the metal oxide surface. Furthermore, the environmentally friendly use of the modifiers based on carboxylic acid is offset by the additional use of fluorine-containing dispersing and binding agents.

Patent EP2553026B1 describes the post-treatment of metal oxide particles and/or metal hydroxide particles for use in cosmetic products based on titanium and in a size range of 5-100 nm.

The object of the invention was therefore to hydrophobize textiles loaded with metal oxide, wherein the hydrophobing agent presented here is non-toxic and environmentally friendly, adhering to the metal oxide surface considerably more stably and without the use of additional dispersants and binders, which also takes environmental aspects into account.

The present invention comprises the coating and modification of textile materials in order to provide them with water-repellent properties. For this purpose, metal oxide particles and/or metal hydroxide particles of groups IVB, IIB and IIIA, preferably of the metals Al, Ti or Zr or mixtures thereof and, in particular, the corresponding particles of the metal Al are first applied to said textiles. The particles mentioned are in a size range of 110 nm-10 μm and, in particular, in the range of 110 nm-1 μm and are attached to the corresponding textile fibers by means of the application process without any additional binder.

The textile pieces prepared in this way, loaded with metal oxide particles and/or metal hydroxide particles, are modified in a subsequent modification process with phosphoric or phosphonic acid ester derivatives of the general form OP(OH)₂OR or OP(OH)₂R, wherein R is a hydrophobic residue in the form of aliphatic, branched or unbranched, alicyclic or aromatic hydrocarbon groups having 5-40 carbon atoms, preferably 8-24 carbon atoms, and, in particular, 15-20 carbon atoms. Furthermore, R can also contain polymerizable functional groups.

The modification reagents just described are bound to the surfaces of the metal oxide/metal hydroxide particles adhering to the textiles via the phosphorus-containing anchor groups of the relevant modifier molecules, which have considerably higher stability than corresponding carboxylic acid derivatives, but are also non-toxic and environmentally friendly.

In contrast to the method presented in patent EP2102406B1, the textile is not hydrophobized by the application of already hydrophobic particles to the textile fibers, but by treatment of the textile loaded with unmodified particles by bringing it into contact with the above-mentioned phosphorus-containing hydrophobic agent. Ideally, contact is made by immersion of the textile to be hydrophobized in a solvent containing the hydrophobing agent, wherein any excess hydrophobing agent is optionally washed off after the treatment.

The subject matter of the invention is explained below with reference to figures, without the subject matter of the invention being restricted thereby. It shows:

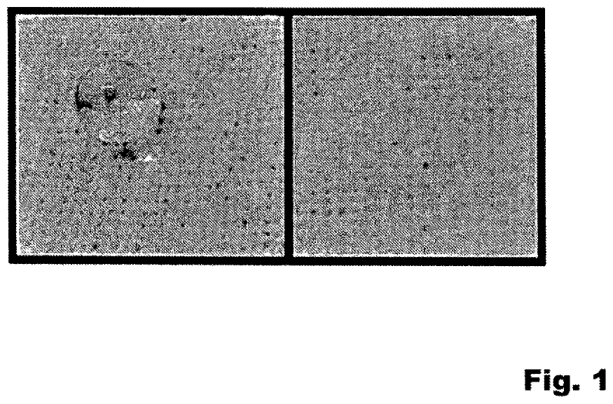

FIG. 1 on the left side, a drop of water on textile (loaded with Al₂O₃ and modified with oleyl phosphate) and, on the right side, a (sunken) drop of water on textile (loaded with Al₂O₃ and not modified),

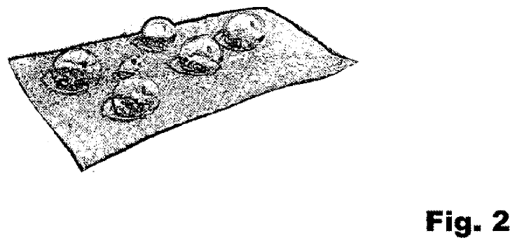

FIG. 2: a photograph of several water droplets on cotton textile modified with C18P,

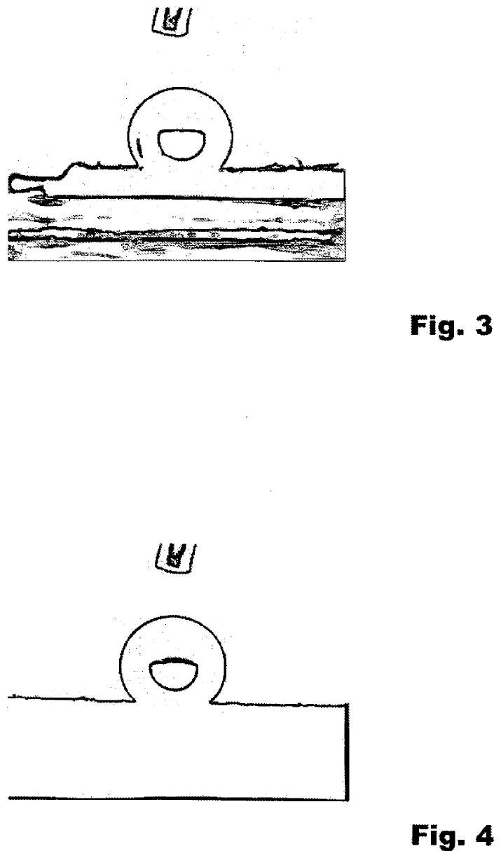

FIG. 3: a photograph of a contact angle measurement of cotton modified with C18P-measured angle 131°,

FIG. 4: a photograph of a contact angle measurement of polyester modified with C12P-measured angle 132.2°

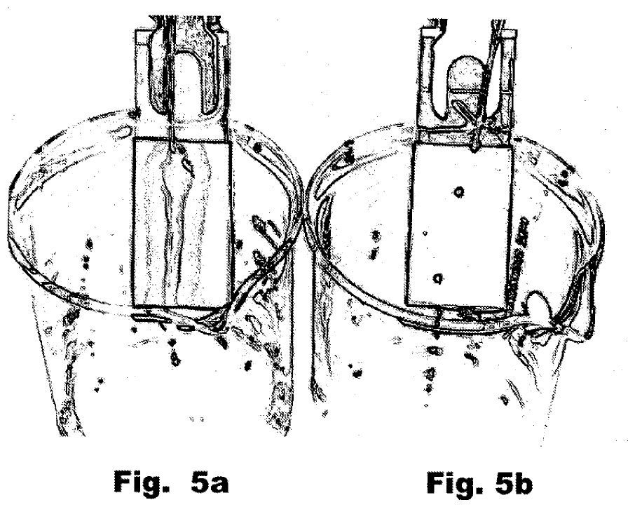

FIG. 5a: a photograph of the beading behavior of unmodified polyester textile and

FIG. 5b: a photograph of the beading behavior of polyester textile modified with C18P.

### Exemplary Embodiment 1

Hydrophobing of Cotton Textiles

Commercial pieces of textile made from cotton fibers were first washed with water in order to remove loose fiber components from the textile. Al₂O₃ particles were then deposited on the previously washed textile in aqueous solution by means of the reaction of suitable aluminum-containing precursor compounds. The particles thus applied were mainly present in a particle size of 1 μm. After loading was complete, the pieces of textile coated with the particles were dried and then placed in a solution comprising oleyl phosphate and ethanol for 1 hour. Thereafter, excess hydrophobing was removed by washing with ethanol, and finally another drying process took place.

The textile made hydrophobic by the above treatment has excellent water-repellent properties, wherein contact angles of >110° are achieved. In contrast, drops of water that are placed on the textile that is only coated with Al₂O₃ particles and is not further modified are immediately absorbed (see FIG. 1).

### Exemplary Embodiment 2

Determination of the Contact Angle on Selected Coated Samples

A cotton sample absorbs water droplets immediately, which is why a contact angle measurement known according to the prior art cannot be carried out directly on the cotton samples.

However, as a result of coating of the sample with octadecylphosphoric acid, the cotton sample constantly has an average angle of 126° (see FIG. 2 for this). In some cases, even around 132° can be measured (see FIG. 3 for this).

For coated polyester samples, on the other hand, values of around 141° can be measured (see FIG. 4 for this).

Examples of measured values are shown in the following table:

| | Contact angle [°], | Contact angle [°], |
|---|---|---|
| Modifier | cotton | polyester |
| none | 0 | 132.2 +/− 2.9 |
| Octylphosphoric | 127.3 +/− 1.0 | 127.1 +/− 2.2 |
| acid (C8P) | | |
| Dodecylphosphoric | 126.6 +/− 2.7 | 137.6 +/− 1.7 |
| acid (C12P) | | |
| Octadecylphosphoric | 126.4 +/− 3.4 | 141.2 +/− 1.2 |
| acid (C18P) | | |

With regard to polyester, this difference in contact angle measurement is not very large, since the fibers are also hydrophobic when unmodified, showing angles of around 132°. However, the contact angle is not the only measure for assessing the water-repellent effect, since unmodified polyester, for example, absorbs water droplets after quite a short time (in the range of 1-2 minutes), while the coated samples do not do so for a period of more than 24 hours.

This can be demonstrated on pieces of textile stretched on solid surfaces, which are dripped with colored water. This shows that unmodified polyester absorbs the water immediately (see FIG. 5a), while the water rolls off the treated samples (FIG. 5b).

As shown in FIG. 5a, when an unmodified polyester textile is brought into contact with colored water, a continuous film of water forms immediately on the surface and is distributed throughout the material by means of absorption of this water, as a result of which the textile is dyed.

As shown in FIG. 5b, when a textile modified with C18P is brought into contact, a very pronounced beading effect takes place, with no wetting of the surface, no absorption and no coloring being discernible.

All features presented in the description, the exemplary embodiments and the following claims can be essential to the invention both individually and in any combination with one another.

1. A method of coating a textile material, the method comprising applying to the textile material metal oxide particles and/or metal hydroxide particles of group IVB, IIB or IIIA or mixtures thereof to form a coated textile material, wherein the particles have a particle size in a size range of 110 nm-10 μm; and treating the coated textile material with a phosphoric acid derivative or a phosphonic acid ester derivative of the general form OP(OH)₂OR or OP(OH)₂R, wherein R includes a hydrophobic hydrocarbon residue comprising 5-40 carbon atoms in the form of a branched or unbranched aliphatic group, an alicyclic group, or an aromatic group.

2. The method of claim 1, wherein the metal oxide particles and/or metal hydroxide particles are particles comprising Al, or Ti, or Zr, or mixtures thereof.

3. The method of claim 1, wherein the particle size of the metal oxide particles and/or metal hydroxide particles the is in a size range of 110 nm-1 μm.

4. The method of claim 1, wherein the residue R comprises 8-24 carbon atoms.

5. The method of claim 1, wherein the residue R further comprises a polymerizable and/or functional group.
